(19) United States
(12) Patent Application Publication
(10) Pub. No.: US 2012/0128867 A1
(43) Pub. Date: May 24, 2012

(54) METHOD OF FORMING CONFORMAL BARRIER LAYERS FOR PROTECTION OF THERMOELECTRIC MATERIALS

(76) Inventor: Charles A. Paulson, Painted Post, NY (US)

(21) Appl. No.: 12/952,531

(22) Filed: Nov. 23, 2010

(51) Int. Cl. B05D 5/12

(52) U.S. Cl. 427/78

(57) ABSTRACT

An atomic layer deposition method for forming a barrier layer over a thermoelectric device comprises providing a thermoelectric device in a reactor, introducing a pulse of a first precursor into the reactor, introducing a pulse of a second precursor into the reactor, introducing an inert gas into the reactor after introducing the first precursor and after introducing the second precursor, wherein the acts of introducing the first precursor and introducing the second precursor are repeated to form a barrier layer over exposed surfaces of the thermoelectric device.

### BACKGROUND

The present disclosure relates generally to hermetic barrier layers, and more particularly to methods for forming hermetic barrier layers configured to protect thermoelectric devices and their attendant thermoelectric materials especially during high temperature operation.

Hermetic barrier layers can be used to protect sensitive materials from deleterious exposure to a wide variety of liquids and gases across a wide range of temperatures. As used herein, “hermetic” refers to a state of being completely or substantially sealed, especially against the escape or entry of water or air, though protection from exposure to other liquids and gases is contemplated.

Approaches to creating hermetic barrier layers include physical vapor deposition (PVD) methods such as sputtering or evaporation, and chemical vapor deposition (CVD) methods such as thermal CVD and plasma-enhanced CVD (PECVD) where a hermetic barrier layer can be formed directly on the device or material to be protected.

By way of example, both reactive and non-reactive sputtering can be used to form a hermetic barrier layer. Reactive sputtering is performed by sputtering a suitable target (e.g., metallic target) in the presence of a reactive gas such as oxygen or nitrogen. The sputtering process results in the formation of a corresponding compound barrier layer (i.e., oxide or nitride) on the surface of an exposed substrate. Although increased throughput can be achieved via reactive sputtering, its inherently reactive nature is generally incompatible with sensitive devices or materials that require protection. Non-reactive sputtering, on the other hand, can be performed using an oxide or nitride target having a desired composition in order to form a barrier layer having a similar or related composition.

Reactive and non-reactive sputtering can be used to form a hermetic barrier layer at room temperature or at elevated temperature conditions. However, because sputtering is a highly directional deposition process, it can be difficult to obtain conformal layers over high aspect ratio substrates using sputtering.

CVD processes, though potentially capable of forming conformal coatings, involve the simultaneous introduction into a reactor of gas phase precursors that may react in the gas phase and form unwanted particles that could compromise the hermeticity of a resulting coating.

In view of the foregoing, economical and device-compatible hermetic barrier layers that can protect sensitive workpieces such as devices, articles or raw materials from undesired exposure to oxygen, water, heat or other contaminants are highly desirable, particularly during exposure at elevated temperatures.

### SUMMARY

According to one aspect of the disclosure, a conformal hermetic barrier layer is formed over a thermoelectric device or a thermoelectric material via atomic layer deposition (ALD). In an embodiment, a thermoelectric device is provided in a suitable reactor. A pulse of a first precursor is introduced into the reactor, followed by a pulse of a second precursor. An inert gas is introduced into the reactor after introducing the first precursor and after introducing the second precursor. The steps of introducing the first precursor and the second precursor are repeated to form a barrier layer over exposed surfaces of the device. The first and second precursors can independently be gaseous precursors or vapor precursors.

According to a further aspect of the disclosure, at atomic layer deposition method is used to form a conformal barrier layer over a pressed powder material. The method comprises providing a pressed powder material in a reactor, introducing a pulse of a first precursor into the reactor, introducing a pulse of a second precursor into the reactor, introducing an inert gas into the reactor after introducing the first precursor and after introducing the second precursor, wherein the acts of introducing the first precursor and introducing the second precursor are repeated to form a barrier layer over exposed surfaces of the pressed powder material.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a schematic of an example thermoelectric device;

FIG. 2 is a schematic illustration of an atomic layer deposition apparatus; and

FIG. 3 is a series of x-ray diffraction scans showing the effect of thermal exposure on thermoelectric materials protected by a hermetic barrier layer according to one embodiment.

### DETAILED DESCRIPTION

A thermoelectric device can generate electric power by converting thermal energy to electric energy. Such a device operates under the principles of the Seebeck effect, in which a temperature gradient induces a flux of electrical carriers across various thermoelectric elements.

Conventional thermoelectric devices use dissimilar conductive materials (i.e., n-type and p-type materials) that are exposed to a temperature gradient to create an electro-motive force, or EMF. The EMF is proportional to the intrinsic thermoelectric power of the elements and the temperature differential between the hot and cold junctions.

The efficiency of a thermoelectric device is generally limited to its associated Carnot cycle efficiency decreased by a factor which is a function of the thermoelectric figure of merit (ZT) of the materials used to fabricate the thermoelectric device. The dimensionless figure of merit ZT represents the coupling between electrical and thermal effects in a material and is defined as

$$ZT = \frac{{S}^{2} σ}{κ} T ,$$

where S, σ, κ, and T are the Seebeck coefficient, electrical conductivity, thermal conductivity, and absolute temperature, respectively.

The electrical resistivity and thermal conductivity of the thermo-elements should be as low as possible in order to reduce both electrical and thermal losses and increase the efficiency.

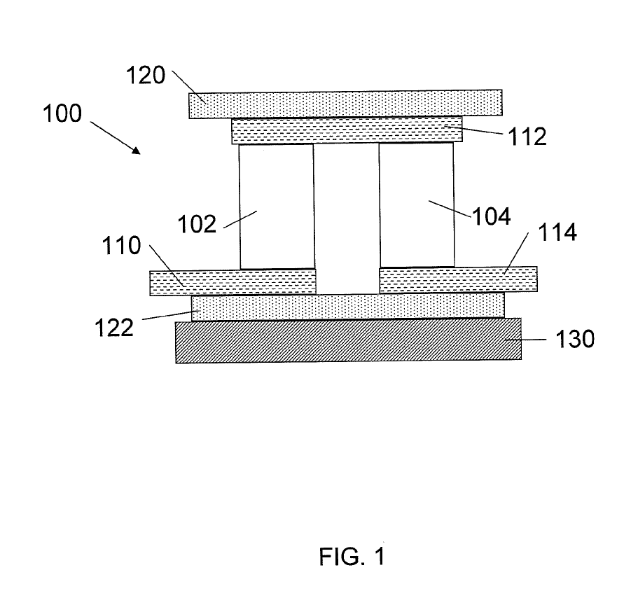

A portion of a typical thermoelectric device 100 is shown in FIG. 1. The device comprises an array of p- and n-type semiconductor elements 102, 104 that are electrically connected in series via electrodes 110, 112, 114 but are thermally connected in parallel via ceramic substrates 120, 122. Shown in FIG. 1 is one pair of p- and n-type elements, which is often referred to as a couple, within the thermoelectric device. A heat sink 130 can be provided on one side of the device.

A wide variety of materials can be used to form a thermoelectric device. Example materials include Bi₂Te₃, PbTe and BiSb, as well as semiconductor alloys such as SiGe, and according to embodiments, materials having the skutterudite crystal lattice structure. Skutterudite materials include, but are not limited to, IrSb₃, RhSb₃, CoSb₃, and CO_{1-x-y}RhₓIr_{y}Sb₃ where 0≦x≦1 and 0≦y≦1, as well as related alloys. Such materials can be suitably doped to form either p-type or n-type elements.

It is often desirable to operate a thermoelectric device across a large temperature gradient to achieve high thermal to electrical efficiency values. The ZT figure of merit for CoSb₃, for instance, can exceed unity at 400° C. However, most skutterudite materials, including CoSb₃, are unstable at such elevated temperatures, and high temperature exposure can lead to their degradation and the concomitant degradation of the underlying thermoelectric device. Common mechanisms associated with elevated temperature degradation of thermoelectric materials include sublimation and thermal oxidation.

Sublimation is a process by which solid material is lost via a phase transformation directly to the vapor phase. Incongruent sublimation can result in undesired changes in stoichiometry. For example, at temperatures greater than about 400° C., germanium can sublime from SiGe, tellurium can sublime from PbTe, and antimony can sublime from skutterudites. Skutterudite materials such as CoSb₃ are also susceptible to oxidation above about 400° C., forming Sb₂O₃ and CoO and other mixed oxides.

Disclosed herein is a method of forming a barrier layer capable of protecting a thermoelectric device by inhibiting oxidation and suppressing sublimation of the constituent thermoelectric materials, particularly at elevated temperature. The barrier layer comprises a thin, continuous and conformal film formed over exposed surfaces of a thermoelectric device (i.e., over the thermoelectric elements). The presence of the barrier layer can significantly decrease oxidation and/or sublimation rates during elevated temperature operation. In embodiments, the barrier layer is formed by atomic layer deposition.

Atomic layer deposition (ALD) is a thin film deposition technique that can be used to form conformal thin films of varying compositions onto a workpiece. ALD involves self-limiting film formation via alternate saturative surface reactions of gaseous precursors. The ALD process is similar to chemical vapor deposition (CVD) except that the ALD approach separates a single CVD reaction into two half-reactions wherein individual precursor materials are temporally distinct during the film forming. By keeping the precursors separate throughout the coating process, atomic layer control of film growth can be obtained.

Separation of the precursors is accomplished by pulsing a purge gas such as nitrogen or argon between successive alternating precursor pulses. The alternating precursors may comprise, for example, metal-containing and non-metal-containing precursors. The purge gas serves to remove excess precursor from the process chamber and inhibit parasitic deposition on the substrate. The first and second precursors can independently be a gaseous precursor or a vapor.

The formation of thin film barrier layers by ALD involves four characteristic steps: 1) exposure within a reaction chamber of a first precursor to a workpiece, 2) evacuation or purging of the reaction chamber to remove non-reacted precursor and gas-phase reaction by-products, 3) exposure of a second precursor to the workpiece, and 4) evacuation or purging of the reaction chamber.

During exposure of the first precursor, individual atoms and compounds may alight on and bond with exposed surfaces of the workpiece. During this initial step, by-products of both gas phase and heterogeneous chemical reactions may be generated. The first purge step can be used to remove un-reacted precursor and any associated by-products from the chamber. In a subsequent step, the workpiece is exposed to a second precursor, such as an oxidant that may react with atoms and compounds that remain on the workpiece surface from the first step. The reaction can result in the formation of a thin layer (1-5 Angstroms thick) of material on the surface. Finally, excess second precursor can be removed from the chamber using a second purge step.

In an example ALD process, an aluminum oxide layer can be formed using a suitable aluminum precursor, such as tri-methyl aluminum (Al(CH₃)₃), together with water vapor as the oxidant. In such a process, a suitable workpiece such as a thermoelectric device can initially be placed into a reaction chamber. The workpiece may, through its exposure to water vapor in air, comprise surface adsorbed water, which may include surface hydroxyl groups. In the first ALD step, tri-methyl aluminum (TMA) is pulsed into the chamber where it can react with the adsorbed hydroxyl groups to fully or partially passivate the exposed surface. A by-product of the reaction between tri-methyl aluminum and the hydroxyl groups is methane. In the second ALD step, excess tri-methyl aluminum (i.e., tri-methyl aluminum molecules that are not adsorbed chemically or physically onto the surface) is removed from the reaction chamber along with the methane. In the third ALD step, water vapor is pulsed into the reaction chamber. The water reacts with dangling methyl groups to form aluminum-oxygen bridges and hydroxyl surface groups, again producing methane as a by-product. In the fourth ALD step, the methane produced as a by-product from the reaction with water is removed from the reaction chamber. In the foregoing example, each four-step cycle produces an approximately 1 Angstrom thick layer of aluminum oxide. The four-step cycle can be repeated to form an aluminum oxide barrier layer.

In certain embodiments, thermoelectric materials may be formed from pressed powders and, as a result, may comprise rough surfaces having high aspect ratio features. The surface roughness in such materials may be characterized by surface features having dimensions on the order of 100 nm. A skilled artisan would appreciate that the precursor exposure times as well as the purge gas cycle times can be optimized to account for both micro-scale and the macro-scale surface features in order to form a conformal, hermetic layer.

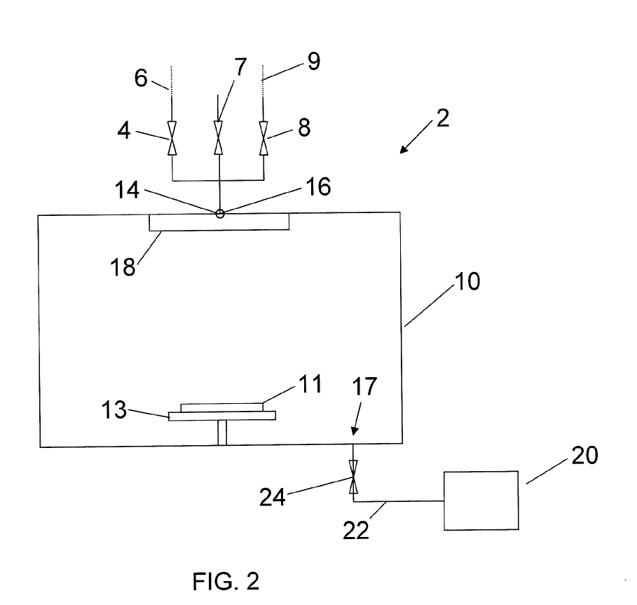

An example apparatus for conducting atomic layer deposition is illustrated schematically in FIG. 2. The apparatus 2 comprises a reactor chamber 10, a first dispensing valve 4 adapted to dispense a first precursor 6 into the reactor chamber 10 through a first precursor inlet 14, a second dispensing value 8 adapted to dispense a second precursor 9 into the reactor chamber 10 through a second precursor inlet 16, and a purge valve 7 adapted to dispense a purge gas into the reactor chamber 10. The first precursor inlet 14 and the second precursor inlet 16 can, as illustrated, share a common opening into the reactor chamber 10, or they can use separate openings.

The apparatus further includes a chamber outlet 17 having an isolation valve 24 connected by way of an exhaust line 22 to an exhaust pump 20. The reactor chamber 10 optionally includes a shower head 18 configured to distribute first and second precursors 6,9 within the process reactor chamber 10, and a workpiece holder/heater 13 for supporting a workpiece 11, such as a thermoelectric device.

ALD can be used to deposit a variety of different materials, resulting in a variety of barrier layer compositions, including various metal oxides (e.g., Al₂O₃, TiO₂, Ta₂O₅, SnO₂, ZnO, ZrO₂, HfO₂) and metal nitrides (e.g., SiNₓ TiN, TaN, WN, NbN), as well as combinations thereof. By selecting particular combinations of starting materials, it is possible to tune various properties of the barrier layer such as, for example the coefficient of thermal expansion (CTE). Minimizing CTE mismatch with thermoelectric materials minimizes cracking or spilling during thermal cycling. Mechanical damage to the barrier layer may compromise its hermetically.

The precursor materials for the ALD process are advantageously volatile yet thermally stable chemicals that are available as liquids or gases. The precursors are preferentially compatible with the workpiece, and do not dissolute into or etch the workpiece, including the associated thermoelectric materials. It will be appreciated that suitable precursor materials can readily be determined by a skilled artisan. Suitable first precursors include, for example, halides, alkoxides, beta-diketonates, alkylamides, amidinates, alkyls and cyclopentadienyls.

Metal halides include a metal atom that is directly bonded to a halogen atom (F, Cl, Br or I), for example TiCl₄. Unfortunately, except for TiCl₄, which is a liquid at room temperature, most metal halides are solids with low volatilities. TiCl₄ can be used to form TiO₂ or TiN.

Metal precursors having oxygen bonded to the metal include alkoxides (M(OR)ₙ), such as hafnium tert-butoxide, Hf(OC₄H₉)₄, where each ligand is bound to the central metal atom through one O atom, and β-diketonates, such as Zr(thd)₄, where each ligand is bound to the central metal through two metal-oxygen bonds.

Alkoxide precursors already possess M—O bonds and consequently, ligand exchange reactions with water maintain the same number of M—O and O—H bonds. The strong dative bonds between the metal center and surface OH groups and the alkoxo O atom and surface metal atoms lead to strongly bound intermediates. Thus, most alkoxide precursors require relatively high ALD temperatures.

Alkoxides can deposit both a metal atom and oxygen atom in a single step when alternated with a second metal precursor, for example, a metal chloride. The kinetics of these reactions are relatively slow, however, and some impurities may remain in the product films.

β-diketonates are common precursors for CVD and have been investigated for ALD of metal oxides. Because they already possess two M—O bonds per ligand, water does not react with these precursors. Strong oxidizers, such as ozone, are typically used to break the strong carbon-oxygen bonds.

Precursors with nitrogen bonded to the metal include metal alkylamides (M(NR₂)ₙ), such as hafnium di-methyl-amide, Hf(N(CH₃)₂)₄ and metal amidinates (M(N₂CR₃)ₙ), such as lanthanum N,N′-di-isopropyl-acetamidinate, where each amidinate ligand chelates the metal center through two M—N bonds. Alkylamido precursors have relatively weak M—N bonds and strong byproduct N—H bonds, lowering the ALD temperature. Alkylamides are reactive to both water and ammonia, enabling nitrogen incorporation into oxide films and even growth of metal nitrides without a plasma.

Organometallic precursors have metal atoms bound directly to carbon, including alkyls M(CₓH_{y})ₙ, such as tri-methyl aluminum, Al(CH₃)₃, and cyclopentadienyls, such as dicyclopentadienyldimethylhafnium, Hf(C₅H₅)₂(CH₃)₂.

Suitable second precursor can include any of the foregoing first precursors and/or an oxygen source such as oxygen, ozone, hydrogen peroxide, or water vapor, or a nitrogen source such as nitrogen, nitrogen oxides, or ammonia. A purge gas, if used, can include argon, nitrogen, or other inert gas.

Optionally, the ALD process can be plasma-assisted, where a plasma step is introduced into the ALD cycle. In plasma-assisted ALD, exposure of the growth surface to reactive species from oxygen, nitrogen or hydrogen plasma, for example, can replace ligand exchange reactions by H₂O or NH₃ used in thermal ALD. The use of plasma can introduce diverse yet selective reactivity to the surface in combination with or without separately heating the workpiece, and facilitate access to process space unattainable by strictly chemical methods. By way of example, alumina films can be synthesized by the combination of tri-methyl aluminum dosing and O₂ plasma exposure, even at room temperature.

In embodiments, a reaction cycle may compromise two or more first precursors, which may be alternately pulsed into the reaction chamber in any desired sequence. The pulse duration for each first precursor may be constant or variable throughout the process, and the pulse duration for respective first precursors may be controlled independently. In one embodiment, an alumina film comprising titanium oxide may be prepared by pulsing a suitable titanium-containing precursor in addition to the aluminum-containing precursor. In one example, a deposition sequence can comprise a four-step cycle carried out with an aluminum-containing precursor that alternates with a four-step cycle carried out with a titanium-containing precursor. In an alternative example, a deposition sequence can comprise multiple successive four-step cycles carried out with an aluminum-containing precursor with intermittent four-step cycles carried out with a titanium-containing precursor.

ALD can be used to form a barrier layer over some or all of the exposed surfaces of thermoelectric device. In embodiments, the disclosed ALD process can be used to deposit a conformal barrier layer that can inhibit temperature-induced degradation. The ALD process can form a barrier layer over the entire device in a single deposition run, which is an improvement over directional deposition processes such as sputtering. Further, the ALD technique is readily scalable to large batch sizes, where many thermoelectric devices can be coated during a single deposition run.

The attendant process for forming hermetic seals for thermoelectric devices is flexible, allowing for the encapsulation of numerous device architectures including, for example, 2-dimensional and 3-dimensional patterned thermoelectric device arrays, and is advantageously compatible with the underlying thermoelectric device layers. Moreover, the process is simple and can be adapted to include a number of different hermetic seal compositions, which facilitates compatibility with both the p-type and n-type materials.

The ALD process can be used to form a uniform, conformal barrier layer that covers substantially all of a thermoelectric device. The barrier layer thickness can be any effective amount, and in embodiments can range from 1 to 100 nanometers (e.g., 1, 2, 4, 10, 20, 50 or 100 nm), where each reaction cycle adds an amount of material to the device surface. The pulse duration for each precursor can range from about 10 msec to 10 sec (e.g., 10, 20, 50, 100, 200, 500, 1000, 2000, 5000 or 10,000 msec). In example embodiments, each reaction cycle may take from 0.5 sec to a few seconds, and result in 0.1 to 1 nm of film thickness. To form a material layer having a desired thickness, the reaction cycles are repeated a desired number of times.

ALD can be a relatively low temperature deposition process, where the temperature of the device during formation of the barrier layer can be about 100-300° C. (e.g., 100, 150, 200, 250 or 300° C.). Thus, oxidation and sublimation can be avoided during the barrier forming process.

A hermetic layer is a layer which, for practical purposes, is considered substantially airtight and substantially impervious to moisture. By way of example, the hermetic thin film can be configured to limit the transpiration (diffusion) of oxygen to less than about 10⁻² cm³/m²/day (e.g., less than about 10⁻³ cm³/m²/day), and limit the transpiration (diffusion) of water to about 10⁻² g/m²/day (e.g., less than about 10⁻³, 10⁻⁴, 10⁻⁵ or 10⁻⁶ g/m²/day). In embodiments, the hermetic thin film substantially inhibits air and water from contacting an underlying device.

Due to the hermetically of the conformal layer the lifetime of a protected device can be extended beyond that achievable using conventional hermetic barrier layers. Barrier layers formed according to the processes disclosed herein can protect underlying thermoelectric materials from thermal degradation, including sublimation and oxidation, at temperatures of 300° C. or higher (e.g., 300, 350, 400, 450, 500, 550 or 600° C.).

### Example

The invention will be further clarified by the following example. A solid test piece comprising compacted CoSb₃ was placed in an ALD deposition chamber. The chamber pressure and substrate temperature were maintained at 80 mTorr and 200° C., respectively. The deposition cycle included tri-methyl aluminum (20 msec), a nitrogen purge (1.5 sec), water vapor (250 msec), followed by a 4 sec nitrogen purge after the water exposure. An alumina (Al₂O₃) barrier layer having a total thickness of about 300 A was formed after 300 total cycles.

A coated sample prepared as described above was placed into an oven with an uncoated reference sample, and the oven temperature was increased at a heating rate of 2° C./min to 500° C. in air. The oven temperature was maintained at 500° C. for 1 hr, and then allowed to cool to room temperature overnight.

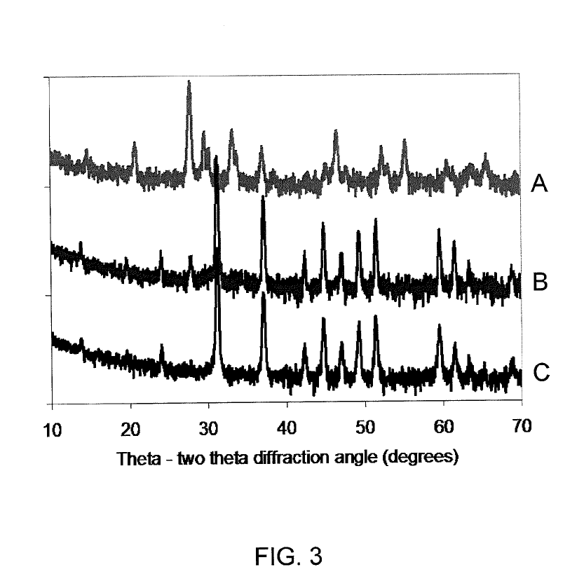

X-ray diffraction (XRD) measurements were performed on each sample prior to and then again following the heat treatment. The XRD results are shown in FIG. 3, where curve A corresponds to a post-annealed uncoated sample (comparative), curve B corresponds to the post-annealed coated sample (inventive), and curve C corresponds to a pre-annealed uncoated control sample (comparative).

With reference to curve A, the un-protected sample shows clear evidence of oxide formation, exhibiting reflections corresponding to oxides of both cobalt and antimony. In particular, a reflection attributable to valentinite (Sb₂O₃) can be seen at 2-theta of about 28 degrees. On the other hand, referring to curve B, the sample comprising the ALD-formed barrier layer shows no visible degradation, where the XRD spectrum is substantially identical to the spectrum corresponding to the un-annealed control sample (curve C). Curves B and C appear to exhibit reflections attributable to CoSb₃.

As used herein, the singular forms “a,” “an” and “the” include plural referents unless the context clearly dictates otherwise. Thus, for example, reference to a “metal” includes examples having two or more such “metals” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An atomic layer deposition method for forming a barrier layer over a thermoelectric device comprising:
providing a thermoelectric device in a reactor;
introducing a pulse of a first precursor into the reactor;
introducing a pulse of a second precursor into the reactor;
introducing an inert gas into the reactor after introducing the first precursor and after introducing the second precursor,
wherein the acts of introducing the first precursor and introducing the second precursor are repeated to form a barrier layer over exposed surfaces of the thermoelectric device.

2. The method according to claim 1, wherein the thermoelectric device comprises a skutterudite material.

3. The method according to claim 1, wherein the thermoelectric device comprises CoSb₃ or an alloy thereof.

4. The method according to claim 1, wherein the inert gas is introduced both after introducing the first precursor and after introducing the second precursor.

5. The method according to claim 1, wherein the first precursor is selected from the group consisting of metal halides, metal alkoxides, beta-diketonates, alkylamides, amidinates, alkyls and cyclopentadienyls.

6. The method according to claim 1, wherein the first precursor is tri-methyl aluminum, and the second precursor is water vapor.

7. The method according to claim 1, wherein the first precursor is selected from the group consisting of an aluminum-containing precursor and a titanium-containing precursor.

8. The method according to claim 1, wherein the barrier layer has an average thickness of from about 1 to 100 nm.

9. The method according to claim 1, wherein the barrier layer has an average thickness of from about 1 to 10 nm.

10. The method according to claim 1, wherein a pulse duration of the first precursor is from 10 msec to 10 sec and a pulse duration of the second precursor is from 10 msec to 10 sec.

11. The method according to claim 1, wherein the thermoelectric device comprises a pressed powder thermoelectric material.

12. The method according to claim 1, wherein the first precursor is selected from the group consisting of a gas and a vapor, and the second precursor is selected from the group consisting of a gas and a vapor.

13. An atomic layer deposition method for forming a barrier layer over a pressed powder material comprising:
providing a pressed powder material in a reactor;
introducing a pulse of a first precursor into the reactor;
introducing a pulse of a second precursor into the reactor;
introducing an inert gas into the reactor after introducing the first precursor and after introducing the second precursor,
wherein the acts of introducing the first precursor and introducing the second precursor are repeated to form a barrier layer over exposed surfaces of the pressed powder material.
